(19) United States
(12) Patent Application Publication
(10) Pub. No.: US 2013/0183364 A1
(43) Pub. Date: Jul. 18, 2013

(54) ANTIMICROBIAL PRODUCT AND METHOD

(71) Applicant: Corey BOTNER, Bismarck, ND (US)

(72) Inventor: Corey BOTNER, Bismarck, ND (US)

(21) Appl. No.: 13/349,144

(22) Filed: Jan. 12, 2012

(51) Int. Cl. A01N 25/08; A01N 31/02; A01P 1/00; A01N 37/52

(52) U.S. Cl. 424/408; 514/635; 514/724

(57) ABSTRACT

An antimicrobial product is provided in which an antimicrobial substance is encapsulated in capsules suspended within a suspending substance. The antimicrobial substance is released upon abrasion of the surface of the antimicrobial product. The antimicrobial product is used to coat surfaces to provide released antimicrobial substance to the hands of someone touching the surfaces.

### BACKGROUND OF THE INVENTION

1. Field of the Invention

This invention relates to sanitizers and other disinfectants, and in particular relates to solid products that contain antimicrobial agents.

2. Description of the Related Art

Pathogenic and other harmful microorganisms are often present in the environment and are regularly transmitted or carried from person to person. Removal and/or killing of these microorganisms, for example, by washing with a soap or detergent, and/or exposure to an antimicrobial agent, are the most common methods for minimizing or removing the risks of disease and infection by the microorganisms. Where there is not concern about human exposure, UV or other radiation and/or heat may be used to kill microorganisms.

There are many substances that are known to be effective as antimicrobial agents, including substances variously known as disinfectants, germicides and other antimicrobials. Examples include many toxic antimicrobial compounds, and compounds that are less dangerous or benign toward humans, such as common household bleach, ethyl alcohol, and chlorhexidine. For use in disinfecting human skin or environments where humans are likely to come in contact with the disinfected surfaces, it is important that the antimicrobial substance(s) that are used be completely nontoxic when used on the skin. In hospital and other environments where it is critical to avoid exposure to harmful microbial pathogens, substances such as ethyl alcohol and chlorhexidine are routinely used. As awareness increases of the dangers of the spread of microorganisms, such as the spread of MRSA (methicillin-resistant Staphylococcus aureus) in hospitals, the availability and use of over-the-counter antimicrobial liquids in public places (hospitals, schools, restaurants, and the like) has increased dramatically. Still, there are many surface areas, such as door handles and other handles, writing implements, and bathroom surfaces, which are touched by many different people each day and which are difficult, impractical, or impossible to treat with an antimicrobial substance after each use or exposure to potentially pathogenic microorganisms.

Typically disinfectant substances are liquids which may be spread, sprinkled, sprayed or otherwise applied to the skin or environmental surface that is to be disinfected. Quick-drying disinfectant gels, such as those found in U.S. Pat. No. 7,824,665 of Miyamoto et al., are often used. There are also various delivery systems that are used to apply antimicrobial substances. See for example, U.S. Pat. No. 7,935,093 of Hanifl et al. for a blended cloth impregnated with a disinfectant solution having chlorhexidine gluconate as an active ingredient without alcohol. The disclosure of these patents and all other patents or publications referred to herein is incorporated herein by reference.

Solid compositions that contain antimicrobial agents are also known, for example, U.S. Pat. Nos. 6,028,113 and 6,518,313 of Scepanski, providing a solid sanitizing nonflowable solid, to which water is added to produce a dilute solution of the sanitizing compound. The solid sanitizing compound may be produced by 1) forming a melted composition containing antimicrobial compounds and an alkaline cleaning composition; 2) heating a solution of antimicrobial compounds to remove solvent; 3) melting a solid carrier and then mixing in a powdered antimicrobial composition; or 4) mixing an aqueous solution of an antimicrobial compound with an anhydrous hydratable salt to form a homogeneous dispersion.

In the field of chemical methodology, there are innumerable methods known in the art of encapsulating active ingredients so that, for example, the active ingredients are released either at a controlled rate or when an external force causes the encapsulating agent to be broken. Examples include the methods of De Roos et al. (U.S. Pat. No. 6,325,859, for a process for preparing beads as a food or tobacco additive, such as in gum or biscuits, where chewing causes flavoring in the beads to be released); Sokoll et al. (U.S. Pat. No. 6,623,764, for a biodegradable targetable microparticle delivery system for delivering vaccines by various immunization routes); Hubbell et al. (U.S. Pat. No. 5,843,743, for gels for encapsulation of biological materials such as tissues, cells or biologically active materials); Bouwmeesters et al. (U.S. Pat. No. 6,436,461, for a process for preparing gel beads as food additives); and Carlsson et al. (U.S. Pat. No. 6,838,089, for an antigen delivery system using a polymer particle vaccine delivery system).

Encapsulated components have been incorporated into soap bars to enhance deposition of active ingredients and sensory markers onto skin. In U.S. Pat. No. 7,208,460, a controlled delivery system for soap bars has a carrier system for controlled delivery comprising a free-flowing powder of solid hydrophobic, positively charged nanospheres of encapsulated ingredients encapsulated in moisture sensitive microspheres. These microspheres burst when the soap is used for washing due to triggering by the moisture used in the washing. In U.S. Pat. No. 7,248,703 extruded detergent bars have benefit agent containing capsules that withstand extrusion but release the benefit agent upon washing.

In Patel et al. (U.S. Pat. No. 6,923,988), solid pharmaceutical compositions are provided that include a solid carrier that includes a substrate and an encapsulation coat on the substrate (can include pharmaceutically active ingredients, hydrophilic surfactants, lipophilic surfactants and triglycerides) for delivery of drugs, nutritional agents, cosmeceuticals and diagnostic agents. Use of encapsulation for antimicrobial substances in such solid compositions is unknown. Encapsulation of antimicrobial substances in such a water-removable form (as in a soap) would cause the medium in which the microcapsules were embedded to be washed away and be rendered useless.

It is therefore an object of the invention to provide an antimicrobial product in which an antimicrobial substance is encapsulated, and in which the antimicrobial substance is released upon abrasion of the surface of the antimicrobial product.

It is a further object of the invention herein to provide an antimicrobial product that is used to coat surfaces to provide released antimicrobial substance to the hands of someone touching the surfaces.

Other objects and advantages will be more fully apparent from the following disclosure and appended claims.

### SUMMARY OF THE INVENTION

The invention herein is an antimicrobial product in which an antimicrobial substance is encapsulated in capsules suspended within a suspending substance. The antimicrobial substance is released upon abrasion of the surface of the antimicrobial product. The antimicrobial product is used to coat surfaces to provide released antimicrobial substance to the hands of someone touching the surfaces and to keep the surface free of microorganisms and prevent their growth.

Other objects and features of the inventions will be more fully apparent from the following disclosure and appended claims.

### DETAILED DESCRIPTION OF THE INVENTION AND PREFERRED EMBODIMENTS THEREOF

The invention herein is an antimicrobial product, comprising a plurality of capsules, each capsule comprising a core benefit material comprising an antimicrobial substance, and an encapsulating material surrounding the core benefit material; and a solid suspending substance in which the plurality of capsules is suspended, the solid suspending substances having an outer surface; wherein abrasion of the outer surface causes release of the antimicrobial substance from capsules positioned on the outer surface. In addition, released antimicrobial substance on the outer surface keeps the surface clean and free of microbes that are killed by the antimicrobial substance and prevents them from growing on the surface.

It is known in the art to encapsulate a wide variety of types of liquids and solids so that selected encapsulated substance(s) are kept apart from a medium in which the capsules are suspended. As used herein, the term “capsule” and derivative words thereof includes microspheres, microcapsules, microparticles, microfibers, beads, granules, pellets, tablets, agglomerates, crystals, spheroids, seeds, and other terms and structures to the extent that these structures hold (encapsulate) the selected substance(s) to keep them apart from the suspending medium. As used herein the term “core benefit material” includes any antimicrobial substance that is not toxic or otherwise harmful to humans when used in the manner specified in the invention herein.

In the invention herein, the method of encapsulation of the antimicrobial substance may be any known in the art. There are many companies skilled in this, and there are many ways to encapsulate substances. It is thus well-known how to encapsulate a wide variety of substance, including those that have biocidal activity. For example, Microtek Laboratories, Inc. provides methods for microencapsulating biocides or antifouling agents, as well as other substances (see for example, U.S. Pat. No. 7,938,897).

Capsule formation ranges from the nano particle level to the microparticle level. For each size of capsule, microencapsulation is the process of enclosing a core material inside a miniature capsule. Capsule walls as known in the art are made of a variety of materials such as gelatin, wax, natural substances, plastic, or other compounds. In the preferred embodiments of the antimicrobial substance of the invention, encapsulation of chlorhexidine, for example, is by in situ polymerization preferably or interfacial polymerization or polymer-polymer incompatibility (phase separation) as known in the art. Chemicals used to encapsulate chlorhexidine may be melamine formaldehyde (preferred), gelatin, polyvinyl alcohol, urea, acrylics, urethanes, polyurea, synthetic waxes, cellulose acetate butyrate, enteric coatings or vinyl acetate copolymers. Encapsulation of ethanol is preferably by spray drying, spray chilling or fluid bed, using melamine formaldehyde, urea formaldehyde, gelatin, polyurea or other appropriate substances as known in the art and accessible to one of ordinary skill in the art without undue experimentation.

The typical methods of release of the core material from microcapsules are bursting, diffusion, dissolution or constant. In the invention herein, capsules preferably release the antimicrobial substance by mechanical rupture (impact, shear, pressure, or other mechanical means).

The antimicrobial substance that forms all, or at least the active portion, of the core benefit material may be any antimicrobial substance that is not harmful to humans and that may be encapsulated. Primary disinfectants preferred in the invention herein as known in the art include:

1. Chlorhexidine, a chemical antiseptic that is effective on both Gram-positive and Gram-negative bacteria. Chlorhexidine is also effective against fungi and enveloped viruses. This antiseptic does not evaporate quickly so it gives the protection to the surface for up to 8 hours.

2. Alcohol based, preferably an ethyl alcohol (Ethanol) however an ethanol and isopropanol alcohol mixture could be used that increases its effectiveness as an disinfectant. High concentration mixtures (such as 80% ethanol+5% isopropanol) are required to effectively inactivate lipid-enveloped viruses (such as HIV, hepatitis B, and hepatitis C). The efficacy of the alcohol mixture may be increased by adding with a wetting agent dodecanoic acid (coconut soap). The synergistic effect of 29.4% ethanol with dodecanoic acid is effective against a broad spectrum of bacteria, fungi, and viruses. Alcohol has great disinfectant properties but quickly evaporates as to not give any extended protection, thus mixing with chlorhexidine would cover a greater spectrum for extended times. Secondary disinfectants as known in the art that also may be used in the invention include:

3. Aldehydes, such as formaldehyde and glutaraldehyde

4. Oxidizing agents, such as sodium hypochlorite(chlorine bleach), calcium hypochlorite, Chloramine-T, Hydrogen peroxide and or a hydrogen peroxide colloidal silver mixture, Peracetic acid (hydrogen peroxide with acetic acid), and Potassium peroxymonosulfate.

5. Phenolics, such as Phenol, Phenylphenol(less corossive), Chloroxylenol, Thymol, Amylmetacresol.

6. Silver

Preferably the antimicrobial substance is selected from the group consisting of chlorhexidine-containing antimicrobial compounds and ethyl alcohol. Most preferably the antimicrobial substance comprises a chlorhexidine-containing antimicrobial compound. Other nontoxic and non-harmful substances as are known in the art may be included in the encapsulating material or within the capsule with the core benefit material without departing from the invention herein.

The preferred solid suspending medium comprises a silicone compound. Silicones, formally called polymerized siloxanes or polysiloxanes, are mixed inorganic-organic polymers with the chemical formula [R₂SiO]ₙ where R is an organic group such as methyl, ethyl, or phenyl, and there is an inorganic silicon-oxygen backbone with organic side groups attached to the silicon atoms. The consistency of silicones can vary from liquid to gel to rubber to hard plastic. Preferably in the invention herein, the silicones used have a rubberlike consistency, such as is found in caulk. Silicones are inert, synthetic compounds that are typically heat-resistant and rubber-like. The useful properties of silicones that make them a preferred suspending medium are that they have low thermal conductivity, low chemical reactivity, low toxicity, thermal stability, the ability to repel water and form watertight seals, resistance to oxygen, ozone and UV light, and good electrical insulation, and do not stick, do not support microbial growth, and have high gas permeability. Silicones are typically used in a wide variety of manners, such as coatings which bond to substrates such as glass, to make baby bottle nipples because of the cleanliness, aesthetic appearance and low extractable content.

The form of silicone used in the invention is preferably as a hardenable gel or rubber with which the capsules described herein can be mixed to form the product of the invention. Preferably, the form of silicone used is a two-part silicone that has a much faster cure time a mold process can be used to form door handles and the like. The resulting mixture is then applied to the desired structure to cover it completely or partly as is desired. Examples of beneficial uses of the invention includes coating of any structure expected to be handled, grasped or touched, including door handles (houses, schools, cruise ships, hospitals, etc.), urinal levers, faucets , subway handles, hand rests, seats, toilet seats, high use chairs, high chairs, shopping carts, pens, elevator buttons, hospital bed railings, telephones (covers), remote controls (covers), headrests, escalator handles, coffee pot handles, furniture handles, handrails, and toilet levers.

Alternatively, silicones can be formed into tapes as known in the art, with the capsules of the invention herein being mixed into the silicone during the tape formation process. The resulting tape can then be used to wrap around the desired structure or to be placed on it in a location most likely to be grasped or touched by people.

As an alternative to silicones, other substances in which encapsulated core materials may be suspended so that abrasion of the surface of the substance can cause release of the encapsulated core materials may be used, such as polyvinyl chloride and other plastics that may be used to form coatings or tapes as is known in the art. The invention also includes any natural or synthetic polymer, polymer formulation or composition that is capable of holding capsules according to the invention herein and capable of releasing antimicrobal substances held within the capsules when the surface is abraded, including but not limited to natural polymers, such as natural rubber and cellulose, and synthetic polymers, such as neoprene, synthetic rubber, nylon, PVC (poly vinyl chloride), polystyrene, polyethylene, polyisoprene, acrylonitrile butadiene, and polyurethane.

The invention herein also includes a method of treating a structure so that the treated structure has antimicrobial properties. The structure is preferably any structure that is regularly touched by humans, such as with their hands. For example, the structure may be any of those mentioned above. The structure to be treated is encased the antimicrobial product of the invention.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. An antimicrobial product, comprising:
a) a plurality of capsules, each capsule comprising a core benefit material comprising an antimicrobial substance, and an encapsulating material surrounding the core benefit material; and
b) a solid suspending substance in which the plurality of capsules is suspended, the solid suspending substances having an outer surface; wherein abrasion of the outer surface causes release of the antimicrobial substance from capsules positioned on the outer surface.

2. The antimicrobial product of claim 1, wherein the antimicrobial substance is selected from the group consisting of chlorhexidine-containing antimicrobial compounds and ethyl alcohol.

3. The antimicrobial product of claim 2, wherein the antimicrobial substance comprises a chlorhexidine-containing antimicrobial compound.

4. The antimicrobial product of claim 1, wherein the solid suspending medium comprises a silicone compound.

5. The antimicrobial product of claim 1, wherein the solid suspending medium is a rubbery solid.

6. The antimicrobial product of claim 1, wherein the solid suspending medium comprises a tape.

7. The antimicrobial product of claim 1, wherein the encapsulating material is melamine formaldehyde.

8. A method of treating a structure so that the treated structure has antimicrobial properties, comprising:
a) preparing the antimicrobial product of claim I; and
b) encasing the structure with the antimicrobial product of claim 1.

9. The method of claim 8, wherein encasing the structure with the antimicrobial product comprises selected a structure from the group consisting of door handles, urinal levers, faucets , subway handles, hand rests, seats, toilet seats, high use chairs, high chairs, shopping carts, pens, elevator buttons, hospital bed railings, telephones (covers), remote controls (covers), headrests, escalator handles, coffee pot handles, furniture handles, handrails, and toilet levers.

10. The method of claim 8, further comprising selecting the antimicrobial substance from the group consisting of chlorhexidine-containing antimicrobial compounds and ethyl alcohol.

11. The method of claim 8, wherein the solid suspending medium comprises a silicone compound.

12. The method of claim 8, wherein the solid suspending medium comprises a tape.

13. The method of claim 8, further comprising preparing the antimicrobial product using in situ polymerization to form the capsules.

14. A structure having antimicrobial properties, comprising a structure encased with the antimicrobial product of claim 1.

15. The structure having antimicrobial properties of claim 14, wherein the antimicrobial substance is selected from the group consisting of chlorhexidine-containing antimicrobial compounds and ethyl alcohol.

16. The structure having antimicrobial properties of claim 14, wherein the solid suspending medium comprises a silicone compound.

17. The structure having antimicrobial properties of claim 14, wherein the solid suspending medium comprises a tape.

18. The structure having antimicrobial properties of claim 14, wherein the encapsulating material is melamine formaldehyde.
